(19) United States
(12) Patent Application Publication
(10) Pub. No.: US 2016/0063066 A1
(43) Pub. Date: Mar. 3, 2016

(54) MULTI-CHANNEL QUEUING

(71) Applicant: ELATERAL, INC., Westchester, IL (US)

(72) Inventors: Alexandre Perry Kamel, Castle Pines, CO (US); Peter Blackburn, Farnham (GB); Paul Goater, Farnham (GB)

(21) Appl. No.: 14/783,035

(22) PCT Filed: Apr. 4, 2014
(86) PCT No.: PCT/US14/32996

§ 371 Date: Oct. 7, 2015

Related U.S. Application Data
(60) Provisional application No. 61/853,472, filed on Apr. 8, 2013.

(51) Int. Cl. G06F 17/30

(52) U.S. Cl. CPC G06F 17/30528; G06F 17/30011; G06F 17/30554

(57) ABSTRACT

A multi-channel queue system and process are described. The multi-channel queue system can include a server, a template database, a network, one or more user devices, and a document database. The multi-channel queue process can include, but is not limited to, creating a plurality of documents targeted to a variety of demographics and storing the plurality of documents in a database communicatively coupled to one or more communication systems.

### CROSS-REFERENCE TO RELATED APPLICATION

This application claims the benefit of U.S. Provisional Application No. 61/853,472, filed Apr. 8, 2013.

### BACKGROUND

Single-channel, multi-channel, interactive communication systems and/or digital communication systems, including, but not limited to, web content management systems, digital or interactive dialog management systems, mobile application servers, mobile web servers, email distribution systems, media servers, streaming services, social networking sites, digital display systems, and point of sale terminals must typically compile or receive content from various sources to deliver content to an intended recipient. The recipient can be a device, a system, a person, an interface, etc.

Communication systems are becoming increasingly sophisticated in their ability to (i) utilize data, analytics, contextual information, and other information, and (ii) deliver targeted communications, messages, documents, advertising, promotional content and/or other media. Based on targeting criteria, triggering events, or other specifications governing desired delivery conditions, systems can deliver communication materials to intended recipients. Equipped with information and an ability to dynamically manage delivery of communication materials in near real-time, current communication systems aim to deliver the right content to the right recipient at the right time via the right channel and under the right conditions.

Real-time Communication Systems, or interactive Communication Systems, are able to identify and respond to events in near-real time, and thereby make choices with regard to delivery of desired communications materials based on certain parameters. Such systems must nonetheless have content available for delivery. Assembling or compiling such content dynamically at the point of, or just prior to, such delivery is challenging, and limits the performance of the process.

Because of the inherent limitations of compiling or assembling content in real time, such systems also undermine the ability to prescribe specific characteristics or designs of such content. And, because of the inherent challenges of assembling content in real time to meet diverse and dynamic communications requirements, such systems limit the variety of such documents needed to support a rich array of targeted communication scenarios.

Even when communication systems and available data enable real time detection and rapid determination of which messages to deliver, targeted communications require significant volume and variety of content in order to provide relevant communications reflecting particular intentions given a variety of qualifying parameters. Determining which message to deliver where and when is only part of the challenge. Current systems are available which can generally do so.

Current communication systems are generally able to assemble content components dynamically, in near-real time, based on various criteria at a time of assembly and delivery. Generally, communications have a number of variable components defined in the communication. For example, a web page having a variable graphic image in an upper left region, a variable object in an upper right region, a fixed banner across a lower border, and free text in a body of the communication. This is one of many examples characterizing digital communications across one or more digital communication media.

Each variable component generally has a number of options available for delivery based on criteria at a time of assembly and delivery of the communication. For example, the graphic image in the upper left portion can include options consisting of a beach, a mountain, a forest, or a desert scene in addition to other image variations including a male or a female, a dog or a cat, a tennis racket or a golf club, etc. The images can be selected based on whether a targeted individual or device intended to view the web page meets certain criteria.

Current systems can dynamically select, assemble, and deliver a combination of variable components in near-real time based on a variety of criteria. However, each option for each variable component of the communication must be available to the communication system in order for the system to be able to dynamically select, assemble, and deliver the content. While the selection, assembly, and delivery of components and related content or pages may be done in near-real time, the creation and customization of the underlying component options or versions takes considerably longer, often measured in weeks vs. milliseconds.

A further challenge is related to the design and production of large volumes of a variety of content enabled for targeted event-based interactions, and making pre-designed versions of the content available for rapid delivery in response to events.

### BRIEF DESCRIPTION OF THE DRAWINGS

FIG. 1 is a flow chart of a multi-channel queue process according to one embodiment of the present invention.

FIG. 2 is a graphical chart of a multi-channel queue process according to one embodiment of the present invention.

FIG. 3 is a block diagram of a multi-channel queue system according to one embodiment of the present invention.

### DETAILED DESCRIPTION

Embodiments of the present invention include a process and a system for implementing intelligent templates to quickly and efficiently enable generation of a plurality of versions of a template available to one or more content delivery systems. Typically, a plurality of customized versions of one or more templates, intended to support multiple targeted communications scenarios, can be created. Hereinafter, a customized version of a template will be referred to as a document. The plurality of customized documents created from a template can be quickly retrieved and delivered, on demand, in response to real-time or near real-time events across one or more communications media or channels.

In one embodiment, the process can include design and production of multiple customized documents from one or more templates. The customized documents can then be populated in one or more queues, databases, repositories, or other data staging areas, where the customized documents may be retrieved or fetched on demand by one or more communication systems.

In one embodiment, a system can be implemented to create a plurality of customized versions of a template. The system can implement intelligent templates to create a plurality of customized documents. Generally, the customized documents can be published to a multi-channel queue for subsequent on-demand delivery by various interactive communication systems. In one embodiment, the customized documents can be associated with communications or targeting scenarios. For instance, one or more documents can be selected, retrieved, and delivered by a communication system based on specified parameters. It is to be appreciated that the customized documents stored in queues for delivery can include one or more media types, file formats, and communication channels.

Embodiments of the present invention can allow communications professionals to pre-define specific design attributes of a document. Typically, as many customized documents as are needed can be designed and produced in accordance with specific design requirements and reviewed and pre-approved before delivery. Since the customized documents can be prepared in advance and be ready for instant delivery on demand, with no need for dynamic assembly or compiling, performance characteristics can be improved including, but not limited to, increased speed and reduced latency. Generally, by preparing the customized documents in advance and populating a queue whereby the customized documents may be retrieved on demand, and by establishing access and usage rights by means of authentication keys and related usage parameters, an ability to control and manage conditions under which materials can be accessed and used can be improved.

Embodiments of the present invention can enable a large variety of customized documents to support relevant interactive communications and experiences. Typically, each version of a template intended for distribution can be made available to a plurality of communication systems operating in relevant communications domains. For example, two or more different web content management systems, or email distribution systems may retrieve the same document.

Generally, a many-to-many relationship between versions of one or more templates in a queue and one or more communication systems that retrieve and distribute documents can be implemented. For example, a customized document can be distributed via multiple communication systems and a communication system may distribute multiple customized documents created from a template.

In some embodiments, authentication keys can be implemented to provide access to one or more documents. For instance, communication systems can be assigned different access rights and usage permissions based on the authentication keys. For example, not all communication systems may access all or similar subsets of documents. In one embodiment, each of the documents can contain a specified code acting as a key. For instance, the specified code can be located in metadata, file identification code, or another specified attribute of the document. In order to access and distribute documents, a communication system must authenticate the key.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), an erasable programmable read-only memory (EPROM or Flash memory), an optical fiber, a portable compact disc read only memory (CD-ROM), and a digital video disk read only memory (DVD-ROM). Note that the computer-usable or computer-readable medium could even be paper or another suitable medium upon which the program is printed, as the program can be electronically captured, via, for instance, optical scanning of the paper or other medium, then compiled, interpreted, of otherwise professed in a suitable manner, if necessary, and then stored in a computer memory.

### TERMINOLOGY

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

The terms “content analytics” or “asset analytics,” as used in this specification and the appended claims, refer to an assessment and characterization of an asset's demonstrated capacity to contribute to an effectiveness of a communications initiative under a variety of communications contexts with regard to an achievement of a variety of desired outcomes, whether for discrete initiatives, types of initiatives, or cumulative impact across all initiatives where the asset has participated over a span of time.

The term “communications campaign,” as used in this specification and the appended claims, refers to a marketing campaign, an advertising campaign, a public service announcement, etc. The communications campaign can include one or more communications.

The term “communication,” as used in the specification and the appended claims, refers to any type of media adapted to present information.

The term “document,” as used in the specification and the appended claims, refers to an instance of a template. A document can include, but is not limited to, a customized version of a template.

The term “demographic,” as used in the specification and the appended claims, refers to a quantifiable statistic of a given population. Demographics can include, but are not limited to, gender, age, ethnicity, income, home ownership, employment status, employment type, and geographical location.

The term “segment,” as used in the specification and the appended claims, refers to a portion of a demographic. For instance, a segment may include a particular range of ages or range of income.

The term “multi-channel,” as used in the specification and the appended claims, refers to having more than one communication channel. For instance, a first communication channel may be web based and a second communication channel may be mobile based.

### An Embodiment of a Multi-Channel Queue Process

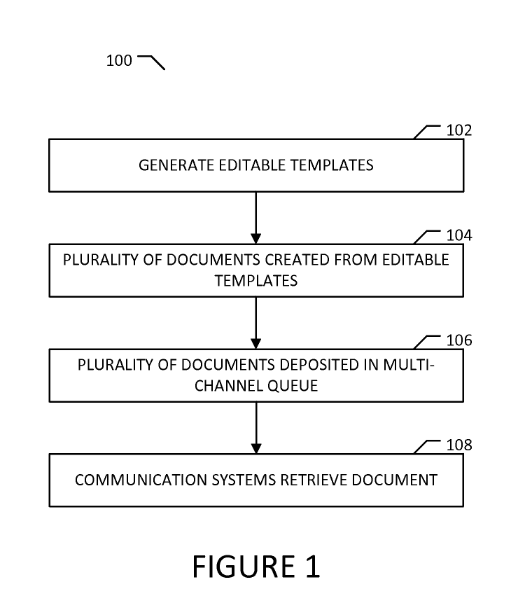

Referring to FIG. 1, a flow chart of a method or process 100 is illustrated. The process 100 can be implemented to populate a database having a queue with one or more versions of a template. Generally, the process 100 can be implemented in systems having a plurality of communication channels. Each version of a template can be referred to as a document. It is to be appreciated that a document can include, but is not limited to, web pages, emails, texts, mobile web pages, mobile application screens, etc. In some embodiments, the process 100 can be implemented to populate the queue with one or more documents created from a plurality of templates.

In block 102, one or more templates each having editable content can be created. Generally, the content can include one or more objects or elements that are variable. For instance, a template may include an image object and a text object. In one example, the image object can be selected from a group of images and the text object can be a WYSIWYG text box. As an example, one version of the template may include a first image and a second version of the template may include a second image.

After the one or more templates are created, a plurality of documents can be created in block 104. As stated previously, the documents can be created from customizing a plurality of versions of each of the templates. For instance, a user may create five different versions of a first template. Each of the five different versions would be a document. Generally, each of the documents can be implemented to target a different demographic. For instance, one document may target males under the age of 30 and a second document may target females over 40. It is to be appreciated that documents can be created to target a variety of different demographics.

In block 106, the plurality of documents can be deposited into a database. In one embodiment, the database can be a multi-channel queue. For instance, the multi-channel queue can store one or more types of documents intended for different media channels. As an example, the multi-channel queue can store a plurality of web advertisements and a plurality of near field communications advertisements. Generally, communication systems adapted to retrieve one or more media types can interface with the multi-channel queue.

In block 108, one or more communication systems can retrieve a document from the multi-channel queue. Generally, the communication system will retrieve or fetch a document in response to a triggering event. It is to be appreciated that a triggering event can vary based on a type of the communication system. For instance, a web based communication system can retrieve a document in response to a user going to an e-commerce site or a web page. It is to be appreciated that the detection of a user or browser of the user by an e-commerce site is one example of a triggering event. The detection of a near-field communication or mobile device signal by a communications or display system can be a triggering event. For example, a user can be detected by a mobile device signal within proximity to a communication system.

Generally, near real time or responsive delivery of communication materials typically occurs in response to certain events based on event detection, action detection, and response sequences. For instance, triggering events can include, but are not limited to, visiting a website, actions taken throughout a visit on a website, social networking site, or within a mobile application, and being in proximity to a near-field communication system can enable detection or monitoring of various actions. Similarly, video monitoring systems can enable detection and tracking of entities and related activities. It is to be appreciated that there are many instances where a presence and/or various actions associated with a person or device can be detected.

Generally, upon detection a series of events may take place. For instance, a communication system can look-up data to determine information, if any, that is available regarding the person or device detected. In another instance, contextual information can be determined if available. Contextual information can included, but is not limited to, geographic location, time of day, temperature, weather, related events, and the like. It is to be appreciated that there are many types of data or information available to communication systems.

After any pertinent information is found, the communication system may deliver communication material to the person or device in response to the event. Typically, the communication material delivered can be based on various criteria. The criteria can be predefined regarding which materials to deliver when, where, under what conditions, etc.

Generally, the multi-channel queue process 100 can be implemented to populate a database with a plurality of documents. The documents can be created to target a specific or general demographic. Generally, each document can be created to target a particular segment of a demographic. As such, the document database can include a variety of documents geared towards a plurality of demographics or other specified audience/recipient targeting criteria. For instance, the database can store documents targeted to wealthy businessmen and rural children.

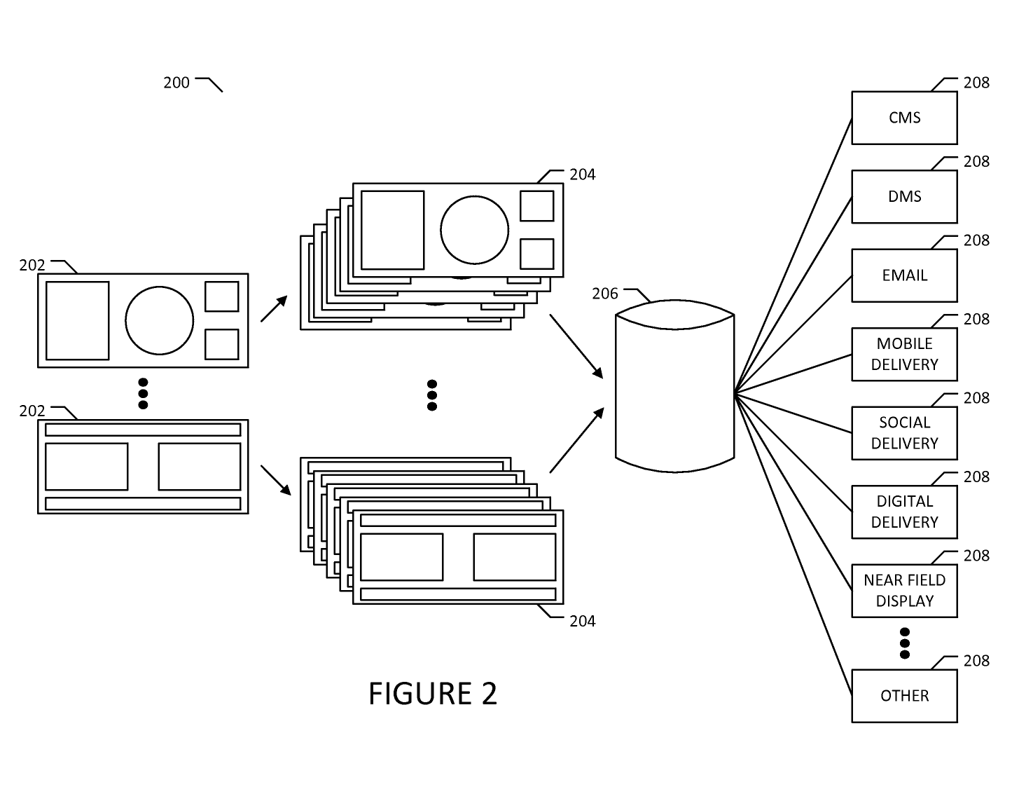

Referring to FIG. 2, a graphical chart 200 illustrating one embodiment of the multi-channel queue process 100 is illustrated.

As shown, the graphical chart 200 illustrates a plurality of templates 202, a plurality of documents 204, a database 206, and a plurality of communication systems 208.

Typically, the plurality of documents 204 can be created from the plurality of templates 202. For instance, each of the plurality of documents 204 can be one version of a template 202. As shown, one or more documents can be created from a template. Generally, each document can be created to target a different demographic. For instance, one document can be created to target men under 30, while a second document created from the same template can be created to target women over 50. Generally, each of the documents can be created for a different target audience.

Once each of the documents 204 is created, the documents can be stored in the database 206. Generally, one or more communication systems 208 can be communicatively coupled to the document database 206. In a typical example, a communication system can experience a triggering event. In response to the triggering event, the communication system 208 can retrieve or fetch a document 204 from the document database 206. Generally, the document that is fetched is geared toward the person or device that caused the triggering event. For example, a user may access a website on their smart phone. The act of accessing or visiting a website can be a triggering event. A communication system can detect the triggering event and retrieve any information related to the user. Based on the information related to the user, the communication system can retrieve a document targeted to the user from the document database. As such, the documents can be delivered dynamically to a user or device.

### An Embodiment of a Multi-Channel Queue System

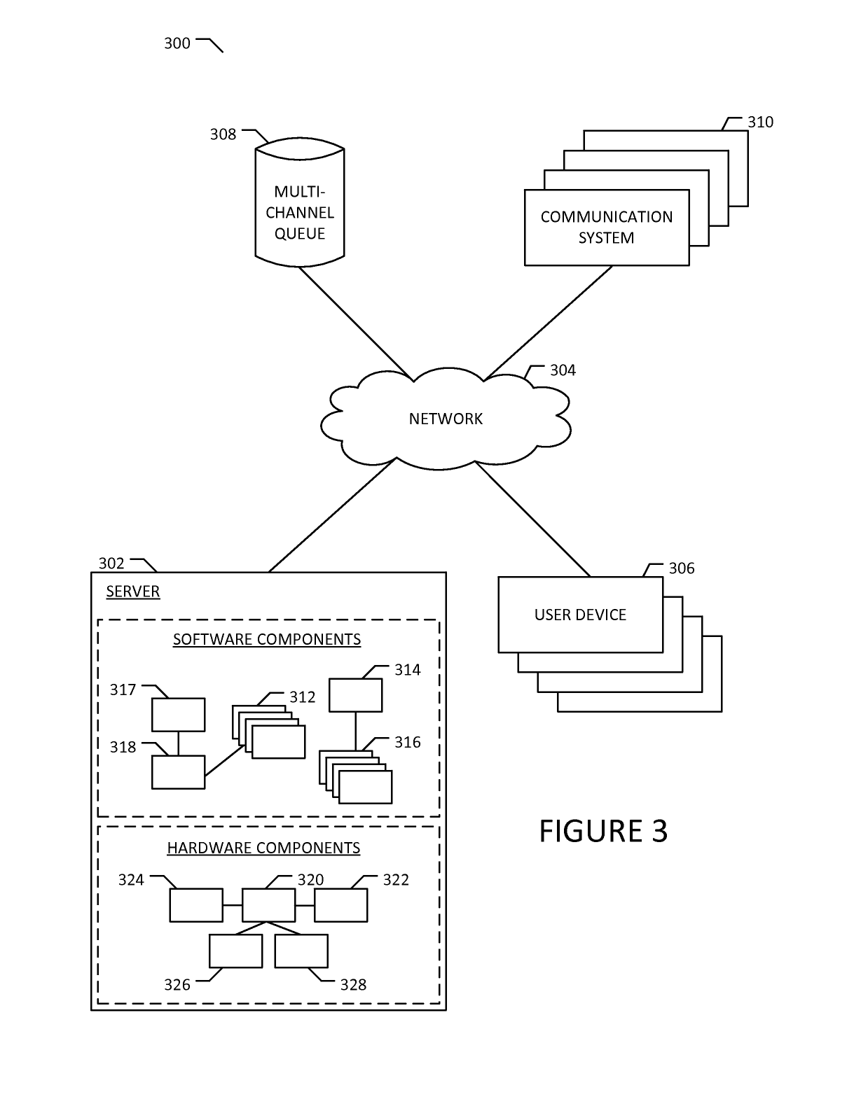

Referring to FIG. 3, a detailed diagram of an embodiment 300 showing a multi-channel queue system is illustrated. The multi-channel queue system 300 can be implemented to create a database having a plurality of documents available for retrieval by one or more communication systems.

Generally, the multi-channel queue system 300 can include a server 302, a network 304, one or more user devices 306, a database 308, and one or more communication systems 310.

Generally, a repository of intelligent templates can be stored in the server 302. In one embodiment, the repository of intelligent templates can be stored in one or more databases 312. It is to be appreciated that the repository of intelligent templates can be stored externally to the server 302. For instance, the template databases 312 can be remotely located from the server 302. Typically, a user can access the template database 312 and search, query, filter, and/or prioritize the repository of templates. For instance, the template database 312 can be accessed through a web interface. In another instance, the user can have direct access to the template database 312. For example, the server 302 can include a user interface 317 or web based interface to access the template database 312.

The server 302 can represent a server or another powerful, dedicated computer system that can support multiple user sessions. In some embodiments, the server 302 can be any type of computing device including, but not limited to, a personal computer, a game console, a smartphone, a tablet, a netbook computer, or other computing devices. In one embodiment, the server 302 can be a distributed system wherein server functions are distributed over several computers connected to a network. The server 302 can have a hardware platform and software components.

Software components of the server 302 can include the one or more databases 312 which can store the plurality of intelligent templates. The software components can also include an operating system 314 on which various applications 316 can execute. A database manager 318 can be an application that runs queries against the databases 312. In one embodiment, the database manager 318 can allow interaction with the databases 312 through an HTML user interface on an end user device 306.

The hardware platform of the server 302 can include, but is not limited to, a processor 320, random access memory 322, and nonvolatile storage 324. The processor 320 can be a single microprocessor, multi-core processor, or a group of processors. The random access memory 322 can store executable code as well as data that can be immediately accessible to the processor. The nonvolatile storage 324 can store executable code and data in a persistent state.

The hardware platform can include a user interface 326. The user interface 326 can include keyboards, monitors, pointing devices, and other user interface components. The hardware platform can also include a network interface 328. The network interface 328 can include, but is not limited to, hardwired and wireless interfaces through which the server 302 can communicate with other devices including, but not limited to, the user devices 306 and the database 308.

The network 304 can be any type of network, such as a local area network, wide area network, or the Internet. In some cases, the network 304 can include wired or wireless connections and may transmit and receive information using various protocols.

The one or more user devices 306 can be any type of computing device on which a browser can operate. Examples of such devices can include, but are not limited to, desktop computers, laptop computers, tablet computers, mobile telephones, game consoles, network appliances, or any other web-enabled devices. In an embodiment, the user devices 306 can have various hardware platforms on which a browser can execute. The browser can be used to access the HTML user interface of the database manager 318.

In one embodiment, the database 308 can be a database where documents are consolidated and stored. For instance, after a plurality of documents are generated from the intelligent templates, the documents can be sent to the document database 308. In one embodiment, the document database 308 can be a queue acting as a buffer. For instance, the document database 308 can be a buffer between the one or more template databases 312 and the one or more communication systems 310.

In one example, a plurality of intelligent templates can be created and stored by one of the databases 312 of the server 302. Generally, one or more of the intelligent templates can be selected by a user of one of the user devices 306. For instance, an initiative designer can select an intelligent template to generate a plurality of documents from. After the documents are created, the documents can be sent to the document database 308. For instance, an application running on the server 302 can implemented to send the created documents to the document database 308. In some embodiments, the application can update the document database 308 as new documents are generated.

In one embodiment, the multi-channel queue system 300 can include a template customization program. Generally, the template customization program can be implemented as an application. It is to be appreciated that the application can be embodied on a variety of computing devices. For instance, the template customization program can be embodied on a user device 306 including, but not limited to, a smart phone, a laptop, a desktop, and a tablet. The template customization program can provide access to the intelligent template database 312.

In one example, a marketing campaign designer can implement the template customization program to access the intelligent template database 312 via the user device 306 having a web browser. While formulating a new communications initiative, the marketing campaign designer can search and select one or more templates for use in the communications initiative. After the campaign designer has selected one or more templates, the campaign designer can customize the templates. Generally, each version of a template can be implemented to target a different segment of the population. After the campaign designer has created a plurality of documents, the template customization program can store the documents in the document database 308. It is to be appreciated that other programs and/or applications can be implemented to store the documents in the document database 308.

In one embodiment, each of the documents can be retrieved from the document database 308 based on a triggering event. For instance, when a communication system experiences a triggering event, a document can be retrieved from the document queue specifically for that triggering event. In one embodiment, the communication system can retrieve data related to the user or device that prompted the triggering event. Based on the data, the communication system can retrieve a specific document for that user or device.

In one embodiment, documents can be uploaded to the document database 308 by a graphic user interface and/or automatically via specified meta-data or other object attributes.

Typically, each of the one or more communication systems 310 can be registered and granted access rights to access and retrieve content from the document database 308. In one embodiment, documents can be registered and assigned to communication systems, campaigns, initiatives, or other such communication channels, systems, or initiatives by means of a graphic user interface or automatically via specified meta-data or other object attributes.

Generally, communication systems can be assigned different access rights and usage permissions. For instance, communication systems may access all documents in the document database 308 or a subset of documents stored in the document database 308. In one embodiment, each of the documents can contain a specified code acting as a key. Generally, the specified code can be located in metadata, file identification code, or another specified attribute of each document. In order to access and distribute documents, a communication system can authenticate the key. In one embodiment, the authentication keys can be set to expire automatically based on elapsed time, date, time, and/or other parameters.

In one embodiment, authentication keys can be adapted to enable or disable documents. For instance, the authentication key can render a document active or inactive. In another instance, the authentication keys can render a document available or unavailable. Typically, the authentication keys can enable or disable documents based on one or more selected parameters. For example, a document may only be available for distribution each Tuesday. In another example, the document may only be available for distribution on weekends or only during certain times of a day. In yet another example, the document may only be available for distribution via specified types of devices or only in specified geographies. It is to be appreciated that a variety of parameters can be implemented to determine an availability of a document.

In one embodiment, authentication keys can be edited and/or updated by remote administrative action in order to disable or enable access rights and privileges associated with the authentication keys. In another embodiment, authentication keys can be edited and/or updated by remote administrative action in order to change access rights, usage rights, privileges and/or other usage parameters.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

1. A method performed on a processor, the method comprising:
creating a first set of documents from a first template, each of the first set of documents targeted to a different segment of a demographic;
storing the first set of documents in a database;
communicatively coupling the database to one or more communication systems;
wherein the one or more communication systems retrieve a first document from the first set of documents based on a first triggering event.

2. The method of claim 1, wherein the one or more communication systems retrieve a second document from the first set of documents based on a second triggering event.

3. The method of claim 1, wherein the demographic is selected from the group consisting of gender, age, ethnicity, income, home ownership, employment status, employment type, geographical location.

4. The method of claim 1, wherein each of the first set of documents is selected from a group consisting of a web page, a mobile ad, an email, a text message, a mobile web page, and a mobile application screen.

5. The method of claim 1, wherein the one or more communication systems are selected from the group consisting of a content management system, a content delivery network, a content delivery platform, a software as a service system, a dialog management system, a mobile application server, a mobile web server, an email distribution system, a media server, a streaming service, a social networking site, and a digital display system.

6. The method of claim 1, further comprising the steps of:
creating a second set of documents from a second template, each of the second set of documents targeted to a different segment of a demographic;
storing the second set of documents in said database;
wherein the one or more communication systems retrieve a document from the second set of documents based on a triggering event.

7. The method of claim 6, wherein the demographic is selected from the group consisting of gender, age, ethnicity, income, home ownership, employment status, employment type, geographical location.

8. The method of claim 7, wherein each of the second set of documents are selected from a group consisting of a web page, a mobile ad, an email, a text message, a mobile web page, and a mobile application screen.

9. The method of claim 6, wherein the first set of documents is a different media type than the second set of documents.

10. A multi-channel queue system comprising:
at least one processor;
at least one computer-readable storage media having stored thereon computer-executable instructions that, when executed by the at least one processor, causes the system to perform a method, the method comprising the following:
creating a first set of documents from a first template, each of the first set of documents targeted to a different segment of a demographic;
storing the first set of documents in a database;
communicatively coupling the database to one or more communication systems;
wherein the one or more communication systems retrieve a first document from the first set of documents based on a first triggering event.

11. The method of claim 10, wherein the one or more communication systems retrieve a second document from the first set of documents based on a second triggering event.

12. The method of claim 10, wherein the demographic is selected from the group consisting of gender, age, ethnicity, income, home ownership, employment status, employment type, geographical location.

13. The method of claim 10, wherein each of the first set of documents is selected from a group consisting of a web page, a mobile ad, an email, a text message, a mobile web page, and a mobile application screen.

14. The method of claim 10, wherein the one or more communication systems are selected from the group consisting of a content management system, a content delivery network, a content delivery platform, a software as a service system, a dialog management system, a mobile application server, a mobile web server, an email distribution system, a media server, a streaming service, a social networking site, and a digital display system.

15. The method of claim 10, further comprising the steps of:
creating a second set of documents from a second template, each of the second set of documents targeted to a different segment of a demographic;
storing the second set of documents in said database;
wherein the one or more communication systems retrieve a document from the second set of documents based on a triggering event.

16. The method of claim 15, wherein the demographic is selected from the group consisting of gender, age, ethnicity, income, home ownership, employment status, employment type, geographical location.

17. The method of claim 16, wherein each of the second set of documents are selected from a group consisting of a web page, a mobile ad, an email, a text message, a mobile web page, and a mobile application screen.

18. The method of claim 17, wherein the first set of documents is a different media type than the second set of documents.

19. A method performed on a computer processor, said method comprising:
creating a plurality of templates;
storing the plurality of templates in a first database;
creating a plurality of documents from the plurality of templates;
storing the plurality of documents in a second database;
retrieving one of the plurality of documents from the second database based on a triggering event.

20. The method of claim 19, wherein documents are retrieved by a communication system selected from a group consisting of a content management system, a content delivery network, a content delivery platform, a software as a service system, a dialog management system, a mobile application server, a mobile web server, an email distribution system, a media server, a streaming service, a social networking site, and a digital display system.

21. (canceled)

22. The method of claim 19, wherein (i) the first database is communicatively coupled to the second database and (ii) the second database is communicatively coupled to one or more communication systems.

23. (canceled)

24. The method of claim 19, wherein the plurality of documents are selected from a group consisting of a web page, a mobile ad, an email, a text message, a mobile web page, and a mobile application screen.

25. The method of claim 19, wherein at least two documents of the plurality of documents are different media types.
